(19) United States
(12) Patent Application Publication
(10) Pub. No.: US 2008/0022833 A1
(43) Pub. Date: Jan. 31, 2008

(54) Device for Severing a Hollow Profile Shaped According to the Internal High-Pressure Deformation Process

(75) Inventors: Thomas Aue, Wedel (DE); Stefan Schwarz, Luenen (DE)

Correspondence Address: CROWELL & MORING LLP;INTELLECTUAL PROPERTY GROUP, P.O. BOX 14300, WASHINGTON, DC, 20044-4300, US

(73) Assignee: DAIMLERCHRYSLER AG, Stuttgart (DE)

(21) Appl. No.: 10/583,326

(22) PCT Filed: Nov. 23, 2004
(86) PCT No.: PCT/EP04/13266

§ 371 Date: Apr. 19, 2007

(30) Foreign Application Priority Data
Dec. 19, 2003 (DE) 103 59 834.0

(51) Int. Cl. B26D 3/00

(52) U.S. Cl. 83/861

(57) ABSTRACT

A device for severing a hollow profile, shaped according to the internal high pressure forming process, transversely to its longitudinal extent, includes an encircling cutting edge arranged in or at an encircling recess formed in an inner wall of the device. In this case, it is essential that sealing elements are provided on the inner wall, with at least one sealing element being arranged in each case on both sides of and parallel to the cutting edge.

### BACKGROUND AND SUMMARY OF THE INVENTION

The present invention relates to a device for severing a hollow profile shaped according to a internal high pressure forming process.

U.S. Pat. No. 5,941,112 discloses a device for the internal high pressure forming and severing of an elongated workpiece transversely to its longitudinal extent. The device has a shaping tool which consists of four adjustable individual molds which are adjusted via hydraulic cylinders. In the joined-together state, the four individual molds define a cavity into which the workpiece to be formed is inserted in the crude state. In addition, the device has an encircling cutting edge which is arranged at an encircling recess and severs the shaped hollow profile at a corresponding internal pressure transversely to its longitudinal extent. Provided at the ends of the hollow profile at a closure of the hollow profile are sealing elements which prevent an escape of the pressure medium during the forming operation.

German document DE 199 09 928 C2 discloses a device for the partial or complete severing of a hollow body shaped according to a internal high pressure forming process. Furthermore, the device has an encircling cutting edge, assigned to which is a supporting body which is arranged to be movable in such a way that it supports that region of the hollow body which is deformed during the cutting operation. The supporting body is inserted into a recess of the tool and surrounds the hollow body. Adjoining the cutting edge is a retaining ring. For the purposes of the internal high pressure forming of the hollow body, the device, the cutting ring and the retaining ring therefore form the requisite bearing surfaces. For the purposes of severing the hollow body, the retaining ring is axially displaced, so that the deforming region of the hollow body can expand radially and extend into the recess. The hollow body is therefore first formed and is then severed by the cutting edge released by the axially displaced retaining ring.

German document DE 198 05 275 A1 discloses a device for pre-cutting and/or for cutting through an aperture in a wall. In this case, one side of the wall can be exposed to a pressurized medium and the other side of the wall can be subjected to a cutting edge acting against this pressure. The cutting edge is formed on the tool, and a punch is movable between a first position, in which it supports the aperture region of the wall during forming, and a second position, in which it releases the cutting edge of the tool, in such a way that the wall can optionally be pre-cut and/or cut through. The device is therefore of two-stage design, in which case the workpiece can be pre-cut in a first stage and can be cut through in a second stage. As a result, the device permits neat cut edges without a die roll.

European document EP 0 491 574 A1 discloses a further device and a method for parting thin-walled hollow bodies.

In particular during the severing of the hollow profiles, undesirable leakage and thus a loss or escape of the pressure medium may occur on account of the high internal pressure. Such an escape of the pressure medium firstly contaminates the device for parting the hollow profiles and secondly makes it difficult to cut neatly through the hollow profiles due to the sudden pressure drop.

The present invention deals with the problem of providing an improved embodiment of a device of the type mentioned at the beginning, in which embodiment an escape of the pressure medium is prevented during the entire parting operation.

This problem is solved according to the invention by the claimed subject matter, with advantageous embodiments forming the subject matter of the dependent claims.

In a device for severing a hollow profile, shaped according to the internal high pressure forming process, transversely to its longitudinal extent, sealing elements are provided on an inner wall and are arranged on both sides of and parallel to an encircling cutting edge. The encircling cutting edge is arranged in or at an encircling recess which is formed in an inner wall of the device. In each case, at least one of the sealing elements is arranged in parallel on a respective side of the cutting edge, as a result of which effective sealing between the inner wall and the hollow profile is achieved, so that escape of a pressure medium is prevented.

This offers the great advantage that, on account of the sealing elements, the parting operation can also be effected during a calibrating operation, at the end of which a hollow profile blank bears completely against the inner wall. In the process, the sealing elements arranged on both sides of the cutting edge prevent the internal pressure from dropping after severing of the hollow profile. In addition, due to the pressure medium being prevented from penetrating between the hollow profile and the device, it is possible to carry out the parting operation before the end of the calibrating operation. The parting operation is therefore uncoupled from the calibrating operation and can also be arranged independently of the calibrating pressure.

Furthermore, the device according to the invention offers a very simple construction, since no additional mechanical devices are necessary. The device according to the invention also provides for scrap-free parting of the individual hollow profile sections, as a result of which material can be saved.

In addition to the severing of the hollow profiles, the device is also suitable for cutting off “dome caps”, which may be designed as dome-like bulges.

According to another embodiment of the invention, the encircling recess is of wedge-shaped design in profile. In this case, the wedge-shaped design merely constitutes a preferred geometrical variant, by means of which the hollow profile in the region of the recess is expanded during or after the severing. This is of great advantage, for example, for producing hollow profile parts which can be coupled to one another, such as tubes for example, since, after every operation for severing the hollow profile, the latter has a push-in tube end at one end and a socket complementary thereto at the other end.

According to an advantageous development of the solution according to the invention, the cutting edge is formed at the transition between the inner wall and the recess. Provision may be made here for the cutting edge to be designed either as an interchangeable parting blade or as an interchangeable cutting edge or for the cutting edge to form an integral part of the inner wall. The interchangeable design of the cutting edge offers the advantage that, after a predefined number of cutting operations, after which the cutting effect of the cutting edge naturally markedly decreases, the cutting edge can simply be exchanged. On the other hand, with a cutting edge integrated in the inner wall, a possible diversity of individual parts of the device is reduced, so that, to renew the cutting edge, it is merely necessary to replace the region of the wedge-shaped recess having the cutting edge. This can offer advantages, for example, during repair or maintenance work, since complicated reception or removal of the cutting edge is dispensed with.

According to a development of the invention, the sealing element is formed from plastic, in particular an elastomer. Plastic seals are common nowadays in machine construction, have been well-proven for many years, and can also be produced cost-effectively and with the most diverse properties. Thus, for example, it is also conceivable for the sealing elements to be formed from a thermally stable plastic or from a plastic having defined compressive strength properties.

According to a further advantageous embodiment, the inner wall has at least one receptacle, into which the sealing element is inserted. This receptacle fixes the sealing element in its position before, during and after the forming operation and thus ensures reliable sealing between the hollow profile and the inner wall. At the same time, the sealing element inserted into the receptacle prevents the same from slipping when the hollow profile blank is moved into position before the forming process or when the finish-formed hollow profile is ejected after the forming process, so that the positioning of the sealing element or sealing elements is always optimal.

Further important features and advantages of the invention follow from the subclaims, from the drawings and from associated description of the figures with respect to the drawings.

It goes without saying that the abovementioned features and the features still to be explained below can be used not only in the respectively specified combination but also in other combinations or on their own without departing from the scope of the present invention.

Preferred exemplary embodiments of the invention are shown in the drawings and are described in more detail below, the same designations designating identical or functionally identical or similar components.

### BRIEF DESCRIPTION OF THE DRAWINGS

FIG. 1 shows a highly simplified sectional illustration through a device according to the invention, with severed hollow profile arranged therein, and

FIG. 2 shows an illustration similar to that of FIG. 1, but with a hollow profile which is not severed and with a different cutting edge.

### DETAILED DESCRIPTION OF THE INVENTION

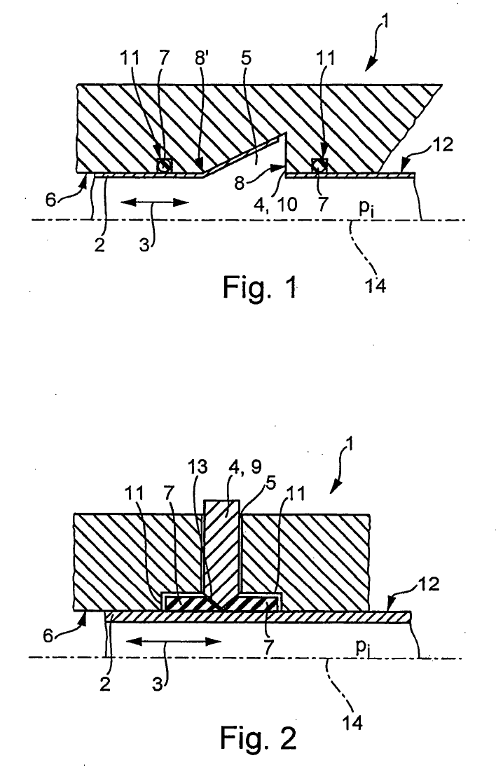

FIG. 1 shows a detail of a device 1 for severing a hollow profile 2, shaped according to the internal high pressure forming process, transversely to its longitudinal extent 3. The hollow profile 2 (only partly shown) is produced before the severing by means of an internal high pressure forming process known per se. To this end, a blank (not shown) is inserted into the device 1 and a forming pressure, that is to say an internal high pressure pᵢ, is expediently applied hydraulically to its inner side, the blank expanding in such a way that it comes to bear on its outer side against an inner wall 6, facing the blank, of the device 1. The hollow profile 2 is thus given a wall 12 which is formed in such a way as to be complementary to the inner wall 6 of the device 1.

Both FIG. 1 and FIG. 2 show a longitudinal section through the device 1 according to the invention, only one part above the section plane 14 being shown.

An encircling cutting edge 4 for severing the hollow profile 2 transversely to its longitudinal extent 3 is arranged according to FIG. 1 on an encircling recess 5 which is formed in the inner wall 6 of the device 1. In this case, according to FIG. 1, the encircling recess 5 is of wedge-shaped design in profile, although a geometrically different design, for example a circle-segment-like design, is also conceivable. In general, the recess 5 is configured in such a way that it expands the hollow profile 2 in the region of the encircling recess 5 during the severing. In the process, an encircling funnel-shaped expansion of the hollow profile 2 is produced after its severing by the wedge-shaped recess 5 according to FIG. 1. In the abovementioned embodiment variant with a circle-segment-like recess 5, a bulge-like expansion is therefore to be expected.

According to FIG. 1, the cutting edge 4 is formed at a transition 8 between the inner wall 6 and the recess 5. In this case, according to FIG. 1, the transition 8 is of right-angled and sharp-edged design, a transition 8′ at that end of the wedge-shaped recess 5 which tapers to a point expediently being rounded off, so that the hollow profile 2 can easily come to bear during the expansion or during the severing. However, a sharp-edged transition in the region of the transition 8′ is also conceivable.

The cutting edge 4 required for severing the hollow profile 2 may either be designed as an interchangeable parting blade 9 of the inner wall 6 (cf. also FIG. 2) or as an integral part 10 of the inner wall 6 or may form such an integral part 10 of the inner wall 6. It is conceivable here for the interchangeable cutting edge 4 or the interchangeable parting blade 9 to be releasably fastened to the transition 8 or, according to FIG. 2, for said cutting edge 4 or said parting blade 9 to simply be interchangeably arranged in the recess 5. Alternatively, however, it is also conceivable, in the case of a cutting edge 4 which has become blunt and forms an integral part 10 of the inner wall 6, for part of the device 1 in the region of the cutting edge 4 to be designed to be interchangeable.

The design of the cutting edge 4 both as an interchangeable parting blade 9 and as an integral part 10 offers advantages on the one hand with regard to the simplicity of the exchange of the cutting edge 4 and on the other hand with regard to a reduction in the individual parts required for the device 1.

According to FIG. 1, sealing elements 7 are arranged on both sides and parallel to the cutting edge 4 and are inserted into a receptacle 11 which is incorporated in the inner wall 6. The two receptacles 11 according to FIG. 1 are in this case arranged at a distance from the wedge-shaped recess 5 more or less in the longitudinal direction 3. The sealing elements 7 which are inserted into the receptacles 11 project in this case at least slightly beyond the inner wall 6, so that a sealed-off connection is obtained when the wall 12 of the hollow profile 2 comes to bear against the sealing elements 7. The higher the internal pressure pᵢ, the greater the contact pressure of the wall 12 against the sealing elements 7 and thus the greater the sealing effect itself.

In contrast to FIG. 1, only one receptacle 11, here a rectangular receptacle 11, is provided in FIG. 2, the two sealing elements 7 being inserted into said receptacle 11 directly adjacent to the cutting edge 4 or the parting blade 9. Both the sealing elements 7 in FIG. 1 and the sealing elements 7 in FIG. 2 may be formed from plastic, in particular an elastomer. As a result, they can be produced cost-effectively and simply and can be individually adapted with regard to their specific properties, such as thermal stability and/or compressive strength for example, to the requirements for the device 1 or the parting operation. In addition, such plastic seals can be easily fitted and removed and have an extremely long life due to the current choice of materials.

According to FIG. 2, the sealing elements 7 conceal the cutting edge 4 and do not release the latter until after certain deformation, i.e. until after a certain internal high pressure pᵢ. From this internal high pressure pᵢ, for example the calibrating pressure, the wall 12 of the hollow profile 2 comes into contact with the cutting edge 4 or the parting blade 9, as a result of which the parting operation is initiated. In contrast to FIG. 1, two expanded parting sections (not designated in any more detail) of the hollow profile 2 are produced in the device 1 according to FIG. 2 when the hollow profile 2 is severed.

In addition, in the embodiment variant according to FIG. 2, it is conceivable for the cutting edge 4 or the parting blade 9 to either be arranged in the recess 5 in a pressure-stable manner or else be additionally pressed against the hollow profile 12 by means of a counterpressure.

In both embodiment variants, the device 1 can be dimensioned in such a way that the hollow profile 2 is severed at a calibrating pressure at which the operation for forming the hollow profile 2 has essentially been completed or at which the wall 12 bears against the inner wall 6 in such a way as to follow the shape.

It is generally the case that both the embodiment variant in FIG. 1 and the embodiment variant in FIG. 2, with regard to their geometrical configurations, for example the geometrical configuration of the recess 5 or of the recess 11 or an arrangement angle (not designated in any more detail) of the cutting edge 4 relative to the hollow profile 2, merely represent one embodiment variant and do not in the least claim completeness, so that other favorable geometrical arrangements and embodiment variants are also included.

In summary, the essential features of the solution according to the invention can be characterized as follows:

In a device 1 for severing a hollow profile 2, shaped according to the internal high pressure forming process, transversely to its longitudinal extent 3, the invention makes provision for sealing elements 7 to be provided on an inner wall 6 of the device 1, these sealing elements 7 being arranged on both sides of an encircling cutting edge 4. The cutting edge 4 is in this case arranged in or at an encircling recess 5 and, for example, is of wedge-shaped design in profile.

The invention therefore simplifies the construction of the device, enables the hollow profile to be severed jointly with or separately from the forming process, produces no material scrap and is also suitable for cutting off dome caps and for end trimming.

1-10. (canceled)

11. A device for severing a hollow profile, shaped according to the internal high pressure forming process, transversely to its longitudinal extent, comprising:
an encircling cutting edge which is arranged in or at an encircling recess formed in an inner wall of the device, and
sealing elements provided on the inner wall,
wherein at least one sealing element is arranged in each case on both sides of and parallel to the cutting edge.

12. The device as claimed in claim 11, wherein the encircling recess is of wedge-shaped design in profile.

13. The device as claimed in claim 11, wherein the recess is configured in such a way that it expands the hollow profile in a region of the recess during severing.

14. The device as claimed in claim 11, wherein the cutting edge is formed at a transition between the inner wall and the recess.

15. The device as claimed in claim 11, wherein the cutting edge either is designed as an interchangeable parting blade or forms an integral part of the inner wall.

16. The device as claimed in claim 11, wherein at least one of the sealing elements is formed from plastic.

17. The device as claimed in claim 11, wherein the inner wall has at least one receptacle, into which at least one of the sealing elements is inserted.

18. The device as claimed in claim 11, wherein the sealing elements conceal the cutting edge and do not release the latter until during deformation.

19. The device as claimed in claim 11, wherein the sealing elements are arranged on both sides of the recess.

20. The device as claimed in claim 11, wherein the device is dimensioned in such a way that the hollow profile is severed at a calibrating pressure at which a hollow profile blank bears completely against the inner wall.

21. The device as claimed in claim 16, wherein the plastic is an elastomer.

22. The device as claimed in claim 12, wherein the recess is configured in such a way that it expands the hollow profile in a region of the recess during severing.

23. The device as claimed in claim 12, wherein the cutting edge is formed at a transition between the inner wall and the recess.

24. The device as claimed in claim 13, wherein the cutting edge is formed at a transition between the inner wall and the recess.

25. The device as claimed in claim 12, wherein at least one of the sealing elements is formed from plastic.

26. The device as claimed in claim 13, wherein at least one of the sealing elements is formed from plastic.

27. The device as claimed in claim 14, wherein at least one of the sealing elements is formed from plastic.

28. The device as claimed in claim 15, wherein at least one of the sealing elements is formed from plastic.

29. The device as claimed in claim 12, wherein the inner wall has at least one receptacle, into which at least one of the sealing elements is inserted.

30. The device as claimed in claim 13, wherein the inner wall has at least one receptacle, into which at least one of the sealing elements is inserted.
